(19) United States
(12) Patent Application Publication
(10) Pub. No.: US 2005/0082511 A1
(43) Pub. Date: Apr. 21, 2005

(54) Thermally stable polyalkylene glycols as lubricants for refrigerators

(76) Inventors: Klaus Poellmann, Burghausen (DE); Anton Strasser, Altoetting (DE); Oliver Pfueller, Sulzbach (DE); Josef Kapfinger, Falkenberg (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/506,486

(22) PCT Filed: Feb. 26, 2003
(86) PCT No.: PCT/EP03/01928

(30) Foreign Application Priority Data
Mar. 7, 2002 (DE) 102 09 987.1

(51) Int. Cl. F25D 1/00; C09K 5/00; C10M 101/00

(52) U.S. Cl. 252/68

(57) ABSTRACT

Disclosed are the use of compounds of formula 1, R¹[(I[CH₂L_{K}—0]—(A-O)ₙ—(B—O)ₘ—R²]_{q} (1), in which R¹ represents an aromatic radical with 6 to 18 carbon atoms, R² represents hydrogen, C₁ to C₁₈ alkyl, or C₆ to C₁₈ aryl, A represents an ethylene radical, B represents an isopropylene radical, k represents zero, 1, or 2, (n+m) represents a number between 3 and 20, n being at least 1, and q represents 2, 3, or 4, and in which the sequence of ethylene units and propylene units is statistical if m and n are both larger than zero, as a basic oil for formulating lubricants, and corresponding lubricants.

The present invention relates to thermally stable polyalkylene glycol base oils for lubricants, and to their use for formulating lubricants for refrigerating machines, heat pumps and related units, for instance air conditioning units. In particular, the invention relates to thermally stable lubricants for refrigerating machines which use carbon dioxide as a refrigerant.

Polyalkylene glycols, i.e. copolymers of ethylene oxide and propylene oxide, have been used for many years as base oils for highly different lubricant applications as a consequence of their high viscosity indices, low pressure-viscosity dependences and low pour points (J. Fahl, KI Luft und Kältetechnik 8, 2000, page 356-360). In general, formulations are used which contain polyalkylene glycols as the predominant constituent. In addition, the formulations comprise a multitude of additives to optimize the properties, for example antioxidants, wear protection additives, EP additives and aging protection additives.

In the field of automotive air conditioning units, units which are operated with the refrigerant R134A require, for compressor lubrication, polyalkylene glycols which have been etherified terminally with alkyl groups (random ethylene oxide/propylene oxide copolymers), for example. As a consequence of their chemical structure, these lubricants have outstanding lubrication and viscosity properties (J. Fahl, E. Weidner, KI Luft und Kältetechnik 10, 2000 page 478-481).

These polyalkylene glycols are generally synthesized by anionically or cationically catalyzed, ring-opening copolymerization of ethylene oxide, propylene oxide and optionally higher aliphatic epoxides, starting from an initiator or starter molecule having active/acidic hydrogen atoms. To modify the properties, the polymerization is optionally followed by an etherification of the resulting free hydroxyl groups with alkyl radicals.

As a result of ecological considerations, attempts are currently being made to develop cold compressors using carbon dioxide as the refrigerant. As a result of the higher pressures and thermal stresses in the system, occurring in comparison to R134A, when CO₂ is used either in the super- or in the subcritical region, higher demands are also made there on the ability of the lubricants to withstand thermal stress.

The polyalkylene glycol types which have hitherto been used as lubricants in particular for R134A systems exhibit a pour point of below −35° C, i.e. they lose their flowability only at very low temperatures. In addition, their viscosity is substantially less temperature-dependent than in the case of lubricants based on mineral oil. They can therefore be used within a wide temperature range. However, their thermal stability is inadequate for many applications. In particular, they do not adequately satisfy the thermal stresses which predominate in refrigeration units which are operated with CO₂, as disclosed in WO-A-99/13032.

Aromatic polyethers, for example polyphenyl ethers, exhibit outstanding thermal stabilities, but have pour points down to −20° C. which, are inadequate for use as a lubricant at low temperatures, and too great a viscosity-temperature dependence. (F. Wunsch in “Einsatz synthetischer Schmierstoffe und Arbeitsflüssigkeiten in der Industrie”, Techn. Akademie Esslingen, 1998).

EP-A-0 311 881 and U.S. Pat. No. 4,360,144 describe the use of ethylene oxide-propylene oxide polymers having aromatic starter molecules R and free end hydroxyl groups as a flux for producing circuit boards having increased thermal stability. However, the use of this class of compound as thermally stable lubricant base oils is not disclosed. In addition, the presence of free hydroxyl groups is decisive for the use of these compounds as a flux. In contrast, a low pour point and a flat viscosity-temperature profile are unimportant.

It is thus an object of the invention to develop thermally stable base oils for the use and formulation of cold compressor oils, especially for the use together with CO₂ as a refrigeration medium.

An inventive cold compressor oil should have a pour point, measured to DIN 51597/ISO 2909, of below −25° C. and a thermal stability which enables use at temperatures of above 220° C. In addition, there should be a very minor viscosity-temperature dependence, i.e. the viscosity should rise very little as a function of temperature. However, the most pressing object is to improve the thermal stability in comparison to conventional polyalkylene glycol oils, which can be determined in the case of this class of compound by means of thermogravimetry by the weight loss resulting from thermal oxidation decomposition. A further indication for the increase in the thermal stability is the increase in the flashpoint.

It has been found that, surprisingly, this object can be achieved by the use of alkylene oxide adducts to aromatic initiator molecules which have 2 or more acidic hydrogen atoms as a lubricant for refrigerating machines. The invention thus provides the use of compounds of the formula 1
R¹[([CH₂]ₖ—O)—(A-O)ₙ—(B—O)ₘ—R²]_{q} (1)
where
R¹ is an aromatic radical having from 6 to 18 carbon atoms
R² is hydrogen, C₁- to C18-alkyl or C₆- to C18-aryl
A is an ethylene radical
B is an isopropylene radical
k is zero, 1 or 2
(n+m) is a number from 3 to 20, where n is at least 1, and
q is2, 3 or 4, and where, when m and n are both greater than zero, the sequence of ethylene and propylene units is random
   as a base oil for formulating lubricants.

The invention further provides a process for operating refrigerating machines by utilizing a compound of the formula 1 as a lubricant.

The invention further provides compounds of the formula 1 where R² is a C₁- to C₁₈-alkyl or C₆- to C₁₈-aryl group.

The invention further provides lubricants for refrigerating machines, heat pumps and related units, for instance air conditioning units, which contain between 80 and 100% by weight of compounds of the formula 1. In particular, the invention relates to thermally stable lubricants for those refrigerating machines which use carbon dioxide as a refrigerant. In addition to the compounds of the formula 1, the lubricants may comprise the conventional additives, for example antioxidants, wear protection additives, EP additives and/or aging protection additives.

R¹ is an aromatic radical which can be derived from an aromatic compound having 2, 3 or 4 acidic hydrogen atoms, which have the formula 2
R¹((CH₂)ₖ—OH)_{q} (2).

The number of acidic hydrogen atoms is q. Acidic hydrogen atoms refer to those hydrogen atoms which are released in aqueous solution to form acids. R¹ may be derived from a monocyclic, a polycyclic (nonfused) or a fused aromatic compound. The acidic hydrogen atoms are bonded to oxygen atoms.

Examples of monocyclic aromatic compounds from which R¹ may be derived are
a) hydroxybenzenes 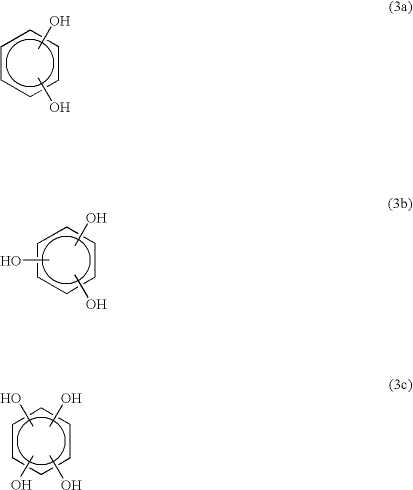
where the OH groups may be in any position relative to each other
b) hydroxyalkylbenzenes 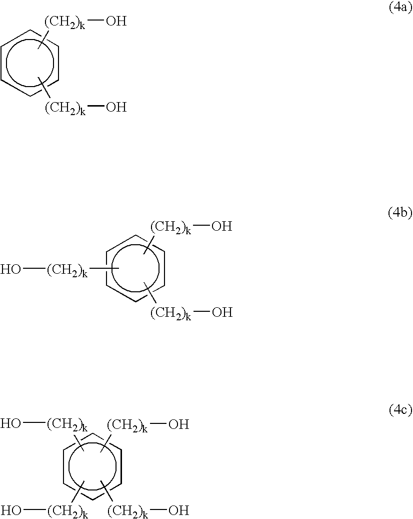
where k=1 or k=2, and the substituents may be in any position.

Examples of polycyclic aromatic compounds from which R¹ may be derived are those of the formula 5 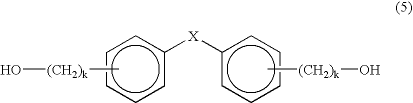
where k is zero, 1 or 2. X is a group of the formulae 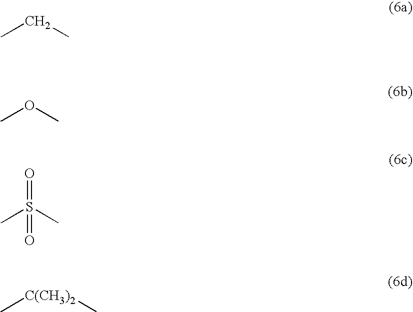
In the compounds of the formula 5, each of the substituents of the formula —(CH₂)ₖ—OH may occur once or twice on each of the aromatic rings, and at any position on the particular ring.

Examples of fused aromatic compounds from which R¹ may be derived are those of the formula 7 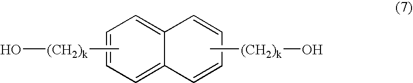
where k is zero, 1 or 2. Here too, each of the —(CH₂)ₖ—OH substituents may occur once or twice on each of the fused rings and be at any position on the particular ring.

The R¹ radical is formed, for example, from the above-disclosed compounds of the formulae 3a to 3c by formal abstraction of the OH groups, or from the compounds of the formulae 4a to 4c, 5 and 7 by formal abstraction of the substituents of the formula —(CH₂)ₖ—OH.

In a preferred embodiment, R¹ is derived from resorcinol (1,3-dihydroxybenzene) or pyrogallol (1,2,3-trihydroxybenzene).

In a further preferred embodiment with particularly low pour point, the sum (m+n) is from 2 to 9, in particular from 3 to 5. It has been found that particularly high thermal stability is achieved with pure ethylene oxide adducts, i.e. when m is zero.

In a further preferred embodiment, R² is an alkyl radical having from 1 to 12 carbon atoms, in particular from 2 to 6 carbon atoms, especially from 2 to 4 carbon atoms.

The inventive compounds can be prepared by alkoxylating and subsequently optionally etherifying the compounds of the formula 2, for example of the formulae 3a to 3c, 4a to 4c, 5 or 7. The synthesis of the inventive compounds proceeds as an anionically initiated ring-opening polymerization in a known manner. To this end, base is first used to form the corresponding anions from the hydroxyl groups of the aromatic initiator molecules which have at least two active hydrogen atoms, and the required stoichiometric amount of an alkylene oxide or of an alkylene oxide mixture is then metered in.

In order to prepare the preferred finally etherified products in which R² is not hydrogen, after the alkylene oxide has reacted to give the hydroxy-functional, aromatic-initiated alkylene oxide adducts, the appropriate alkylating agent (e.g. alkyl halide or alkyl sulfate) additionally has to be metered in in the stoichiometrically required amount. The finally alkylated alkylene oxide adduct can be isolated after washing with water to remove the salt formed in the last reaction step.

### EXAMPLES

### Example 1

110 g of resorcinol were reacted in a pressure reactor with 80 g of NaOH at 120° C. to give the corresponding diphenoxide anion and the resulting water of reaction was distilled off under reduced pressure. Subsequently, the diphenoxide anion was converted to the corresponding resorcinol polyethoxylate by slowly adding 352 g of ethylene oxide within a period of 6 hours. The product was adjusted to pH 6-7 using phosphoric acid and filtered.

The product exhibited a pour point of −44° C. The investigation of the thermal stability by means of thermogravimetry showed 8% weight loss after 20 minutes at 250° C. and 30% weight loss after 100 minutes at 250° C. The plot of the viscosity against the temperature in the 0 to 100° C. range gave a rise of 47.8. The flash point was 315° C.

### Example 2

The product from Example 1 was, without carrying out the neutralization with phosphoric acid, reacted under pressure at 120° C. for 6 hours after once again adding 80 g of sodium hydroxide with 208 g of methyl chloride. After the excess methyl chloride had been removed, the product was washed with water, neutralized and filtered.

The product exhibited a pour point of −44° C. The investigation of the thermal stability by means of thermogravimetry showed 10% weight loss after 20 minutes at 250° C. and 45% weight loss after 100 minutes at 250° C. The plot of the viscosity against the temperature in the 0 to 100° C. range gave a rise of 2.69. The flash point was 300° C.

### Example 3

124 g of pyrogallol were reacted in a pressure reactor with 120 g of NaOH at 140° C. to give the corresponding triphenoxide anion and the resulting water of reaction was distilled off under reduced pressure. Subsequently, the triphenoxide anion was converted to the corresponding pyrogallol polyethoxylate by slowly adding 616 g of ethylene oxide within a period of 6 hours. The product was adjusted to pH 6-7 using phosphoric acid and filtered.

The product exhibited a pour point of −26° C. The investigation of the thermal stability by means of thermogravimetry showed 2% weight loss after 20 minutes at 250° C. and 6% weight loss after 100 minutes. The plot of the viscosity against the temperature in the 0 to 100° C. range gave a rise of 8. The flash point was 315° C.

### Example 4

110 g of resorcinol were reacted in a pressure reactor with 80 g of NaOH at 120° C. to give the corresponding diphenoxide anion, and the resulting water of reaction was distilled off under reduced pressure. Subsequently, the diphenoxide anion was converted to the corresponding resorcinol polyalkoxylate by slowly adding a mixture of 308 g of ethylene oxide and 406 g of propylene oxide within a period of 6 hours. The product was adjusted to pH 6-7 using phosphoric acid and filtered.

The product exhibited a pour point of −28° C. The investigation of the thermal stability by means of thermogravimetry showed 10% weight loss after 30 minutes at 250° C. and 23% weight loss after 100 minutes. The plot of the viscosity against the temperature in the 0 to 100° C. range gave a rise of 31. The flash point was 310° C.

### Comparative Example 1

106 g of propylene glycol were reacted in a pressure reactor with 80 g of NaOH at 120° C. to give the corresponding dialkoxide anion and the resulting water of reaction was distilled off under reduced pressure. Subsequently, the dialkoxide anion was converted to the corresponding ethoxylate by slowly adding 352 g of ethylene oxide within a period of 6 hours. The product was adjusted to pH 6-7 using phosphoric acid and filtered.

The product exhibited a pour point of −25° C. The investigation of the thermal stability by means of thermogravimetry showed already 90% weight loss after 30 minutes at 250° C. and 98% weight loss after 100 minutes at 250° C. The plot of the viscosity against the temperature in the 0 to 100° C. range gave a rise of 3.4. The flash point was 245° C.

### Comparative Example 2

118 g of butyl glycol were reacted in a pressure reactor with 40 g of NaOH at 120° C. to give the corresponding alkoxide anion and the resulting water of reaction was distilled off under reduced pressure. Subsequently, the alkoxide anion was converted to the corresponding butyl polyalkoxylate by slowly adding a mixture of 308 g of ethylene oxide and 406 g of propylene oxide within a period of 6 hours. The product was adjusted to pH 6-7 using phosphoric acid and filtered.

The product exhibited a pour point of −50° C. The investigation of the thermal stability by means of thermogravimetry showed 90% weight loss after 25 minutes at 250° C. and 98% weight loss after 100 minutes at 250° C. The plot of the viscosity against the temperature in the 0 to 100° C. range gave a rise of 1. The flash point was 245° C.

TABLE 1
Results

| | | EO/ | PO/ | PP, | Weight loss | | | Fla. |
|---|---|---|---|---|---|---|---|---|
| No. | Starter | mol | mol | ° C. | 20 min | 100 min | η(T) | Pt. |
| 1 | Resorcinol | 8 | 0 | −44 | 8% | 30% | 47.8 | 315 |
| 2 | Resorcinol | 8 | 0 | −44 | 10% | 45% | 2.69 | 300 |
| 3 | Pyrogallol | 14 | 0 | −26 | 2% | 6% | 8 | 315 |
| 4 | Resorcinol | 7 | 7 | −28 | 10% | 23% | 31 | 310 |
| C1 | PG | 8 | 0 | −25 | 90% | 98% | 3.4 | 245 |
| C2 | BuG | 7 | 7 | −50 | 90% | 98% | 1 | 245 |

1. A formulating lubricant for referigerating machines containing carbon dioxide as the refrigerant comprising a base oil of the formula 1
R¹[([CH₂]ₖ—O)—(A-O)ₙ—(B—O)ₘ—R²]_{q} (1)
where
R¹ is a radical derived from resorcinol (1,3-dihydroxybenzene) or pyrogallol (1,2,3-trihydroxybenzene),
R² is hydrogen, C₁- to C₁₈-alkyl or C₆- to C₁₈-aryl
A is an ethylene radical
B is an isopropylene radical
k is zero, 1 or 2
(n+m) is a number from 3 to 20, where n is at least 1, and
q is 2or 3, and where, when m and n are both greater than zero, the sequence of ethylene and propylene units is random.

2. The formulating lubricant as claimed in claim 1, wherein the sum of m+n is from 3 to 9.

3. The formualting lubricant as claimed in claim 1, wherein R² is an alkyl radical having from 1 to 12 carbon atoms.

4. The formulating additive as claimed in claim 1, wherein m is zero.

5. The formulating additive as claimed in claim 1, wherein k is zero.

6. The formulating additive as claimed in claim 1, wherein R² is a C₁- to C₁₈-alkyl or C₆- to C₁₈-aryl group.

7. A method for operating a refrigerating machine using carbon dioxide as a refrigerating medium, comprising the step of using a lubricant as defined in claim 1.

8. A lubricant comprising a compound of the formula 1
R¹[([CH₂]ₖ—O)—(A-O)ₙ—(B—O)ₘ—R²]_{q} (1)
where
R¹ is an aromatic radical having from 6 to 18 carbon atoms
R² is hydrogen, C₁- to C₁₈-alkyl or C₆- to C₁₈-aryl
A is an ethylene radical
B is an isopropylene radical
k is zero, 1 or 2
(n+m) is a number from 3 to 20, where n is at least 1, and
q is 2, 3or 4, and where, when m and n are both greater than zero, the sequence of ethylene and propylene units is random.
